(19) United States
(12) Patent Application Publication
(10) Pub. No.: US 2002/0154628 A1
(43) Pub. Date: Oct. 24, 2002

(54) Server for gathering and providing information

(75) Inventors: Yoshihiko Akasaka, Nagano-ken (JP); Kenji Akahane, Nagano-ken (JP); Fumiaki Furihata, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/104,061

(22) Filed: Mar. 25, 2002

(30) Foreign Application Priority Data
Mar. 27, 2001 (JP) 2001-090331
Nov. 29, 2001 (JP) 2001-364186

(51) Int. Cl. H04L 12/28

(52) U.S. Cl. 370/352; 370/351

(57) ABSTRACT

Only information that has reached a disclosure day among information registered in a database of a first information providing server (32) having access through an intranet (10) is downloaded to a second information providing server (42) having access through the Internet (20), and the information is provided to clients (22 to 26) that are provided with access rights and that are connected to the Internet (20) from the second information providing server (42). As a result, information that has not reached the disclosure day can be prevented from being leaked by an illegal access to the second information providing server (42). The establishment of access rights makes it possible to hierarchize clients (12 to 16, 22 to 26) connected to the intranet (10) and to the Internet (20).

### BACKGROUND OF THE INVENTION

1. Field of the Invention

This invention relates to a server for and a method for gathering and providing information through a network.

2. Description of the Related Art

As a server for gathering and providing information through a network, a proposal has been conventionally made to use a server that establishes an access right with respect to information that can be provided or a server that establishes an access right with respect to a client that has access to the server. Only a part of the providable information is intended to be provided by thus establishing the right to access the providable information, or an illegal access, such as acts of hacking (i.e., cracking act), is intended to be prevented, and clients are intended to be hierarchized by thus establishing the right to allow each client to access the server.

However, although the information-gathering/providing server establishes an access right and thereby aims to prevent an illegal access, the server is constantly being threatened by the illegal access through acts of hacking or the like because of the network existence. As a result, this illegal access has been highlighted as an enormous problem requiring a solution.

### SUMMARY OF THE INVENTION

An object of a server for and a method for gathering and providing information through a network according to the present invention is to ensure higher security of information to be provided or of information that has been gathered. Another object of a server for and a method for gathering and providing information through a network according to the present invention is to hierarchize clients more appropriately and to prevent information from being leaked by an illegal access. Still another object of a server for and a method for gathering and providing information through a network according to the present invention is to reflect the gathered information in a form of information to be swiftly provided.

In order to achieve at least a part of the aforementioned objects, the server and the method according to the present invention are structured as follows.

An information providing server of the present invention is an information providing server that can provide information to a first network, and the information providing server includes an information storage part for storing predetermined information, an information providing part for providing the stored predetermined information to the first network, a disclosure timing setting part for setting disclosure timing with respect to each of the predetermined information stored in the information storage part, and an information outputting part for outputting information, which has reached the disclosure timing set by the disclosure timing setting part, among the predetermined information to a second information providing server that can provide information to a second network that differs from the first network.

In this information providing server of the present invention, the predetermined information stored in the information storage part is provided to the first network, and the information which has reached the disclosure timing set by the disclosure timing setting part among the predetermined information is output to the second information providing server that can provide information to the second network that differs from the first network. Therefore, since the second information providing server can provide only the information which has reached the disclosure timing among the predetermined information stored in the information storage part to the second network, information that has not reached the disclosure timing among the predetermined information stored in the information storage part can be prevented from being disclosed by an illegal access to the second information providing server through the second network. Document information, for example, can be mentioned as predetermined information, and an intranet can be used as the first network, and the Internet can be used as the second network.

As one aspect, in the information providing server of the present invention structured in this way, the disclosure timing setting part can set a disclosure day as the disclosure timing, and the information outputting part can output information that corresponds to a predetermined time of the disclosure day as the disclosure timing. As another aspect, there can be provided an access right establishing part for establishing an access right for a client and predetermined information that are having access through the first network, and the information providing part can provide information on the basis of the access right established by the access right establishing part. At that time, the access right establishing part may establish prohibitions or permissions that include at least one of the prohibitions against access, permission for only reading, and permission for reading and writing.

As still another aspect, the access right establishing part may establish an access right with respect to each client that has access to the second information providing server through the second network. In this case, the access right establishing part may establish either a prohibitions against access or permission for only reading as an access right with respect to each client that has access to the second information providing server through the second network.

A first double-server system of the present invention is a double-server system that includes a first server that can provide information to a first network and a second server that can provide information to a second network, and the first server includes a first information storage part for storing predetermined information, a first information providing part for providing the stored predetermined information to the first network; a disclosure timing setting part for setting disclosure timing with respect to each of the predetermined information stored in the first information storage part, and an information outputting part for outputting information, which has reached the disclosure timing set by the disclosure timing setting part, among the predetermined information stored in the first information storage part to the second server, while the second server comprises a second information storage part for storing information output from the information outputting part; and a second information providing part for providing the stored information to the second network.

In the first double-server system of the present invention, the predetermined information stored in the first information storage part is provided to the first network from the first server, and the information which has reached the disclosure timing set by the disclosure timing setting part among the predetermined information stored in the first information storage part is output to the second server. The second server stores the information output from the first server in the second information storage part, and provides the stored information to the second network that differs from the first network. Therefore, since only the information which has reached the disclosure timing among the predetermined information stored in the first information storage part of the first server is stored in the second information storage part of the second server, and since only the information stored in the second information storage part is provided to the second network, information which has not reached the disclosure timing among the predetermined information stored in the first information storage part of the first server can be prevented from being leaked by an illegal access to the second server through the second network. Document information, for example, can be mentioned as the predetermined information, and an intranet can be used as the first network, and the Internet can be used as the second network.

As one aspect, in the first double-server system of the present invention structured in this way, the disclosure timing setting part can set a disclosure day as the disclosure timing, and the information outputting part can output corresponding information when reaching the predetermined time of the disclosure day as the disclosure timing. As another aspect, the first server can include an access right establishing part for establishing an access right for a client and predetermined information that are having access through the first network, and the first information providing part can provide information on the basis of the access right established by the access right establishing part. At that time, the access right establishing part may establish prohibitions or permissions that include at least one of the prohibitions against access, permission for only reading, and permission for reading and writing.

As still another aspect, the access right establishing part may establish an access right with respect to each client that has access to the second server through the second network, and the second information providing part may provide information stored in the second information storage part on the basis of the access right established by the access right establishing part. In this case, the access right establishing part may establish either a prohibition against access or permission for only reading as an access right with respect to the client that has access to the second server through the second network.

A method for providing information through a network of the present invention is an information providing method for providing information to a first network and to a second network, and the information providing method includes the steps of (a) storing predetermined information in a first server that can provide information to the first network and providing the predetermined information to the first network, (b) setting disclosure timing with respect to the predetermined information stored in the first server, and (c) storing the predetermined information in a second server that can provide information to the second network and providing the information to the second network when the set disclosure timing is reached.

According to the information providing method of the present invention, only the predetermined information which has reached the disclosure timing is stored in the second server and is provided to the second network, and therefore information which has not reached the disclosure timing among the predetermined information that has been stored in the first server and that is to be provided to the first network can be prevented from being leaked by an illegal access to the second server through the second network.

An information providing/gathering server of the present invention is an information providing/gathering server that is connected to a first network and that provides and gathers information, and the information providing/gathering server includes a first information storage part for storing first predetermined information, an information providing part for providing the first predetermined information that has been stored to the first network, an information inputting part for inputting second predetermined information that has been transmitted from a client computer through the first network, a second information storage part for storing the second predetermined information that has been input, and an information outputting part for, when a request from a host computer connected to a second network different from the first network is received to output the second predetermined information that has been stored in the second information storage part under a predetermined condition, outputting the second predetermined information to the host computer.

In the information providing/gathering server of the present invention, the first predetermined information that has been stored is provided to the first network, and, when a request from the host computer connected to the second network is received to output the information under the predetermined condition, the second predetermined information that has been input from the client computer through the first network and that has been stored is output to the host computer. Therefore, since the host computer does not need to be connected to the first network, the host computer can gather the second predetermined information in high security.

As an aspect, in the information providing/gathering server of the present invention, the first information storage part can store information, which has been input when information that has been adjusted on the basis of the second predetermined information has been input from the host computer, as the first information. As another aspect, there can be provided a firewall that has a security function for the first network.

An information management server of the present invention manages a predetermined server that is connected to a first network and that gathers second predetermined information from the first network in accordance with provisions of the first predetermined information, and the information management server is connected to a second network different from the first network, and the information management server includes an information acquisition part for acquiring the second predetermined information that has been gathered by the predetermined server at a predetermined timing and a database construction part for constructing a predetermined database on the basis of the second predetermined information that has been acquired.

In the information management server of the present invention, the second predetermined information can be acquired from the predetermined server that is connected to the first network and that gathers the second predetermined information from the first network in accordance with provisions of the first predetermined information, and the predetermined database can be constructed on the basis of the second predetermined information that has been acquired. Since the information management server does not need to be connected to the first network, a predetermined database that has been constructed can be prevented from being falsified by an illegal access from the first network. In other words, high security of the constructed database can be achieved.

As an aspect, the information management server of the present invention can further include an information conditioning part for conditioning the first predetermined information from the predetermined database that has been constructed and an information outputting part for outputting the first predetermined information that has been conditioned to allow the first predetermined information to be stored in a predetermined server so that the first predetermined information can be provided to the first network from the predetermined server. As another aspect, the information acquisition part can be designed to acquire the second predetermined information at predetermined intervals with predetermined timing, or can be designed to delete acquired information from a predetermined server when the second predetermined information is acquired from the predetermined server. As still another aspect, there can be provided a firewall that has a security function for a predetermined server.

A second double-server system of the present invention is a double-server system that includes a first server that is connected to a first network and a second server that is connected to a second network, and the first server includes a first information storage part for storing first predetermined information; an information providing part for providing the first predetermined information that has been stored to the first network; an information inputting part for inputting second predetermined information that has been transmitted from a client computer through the first network, and a second information storage part for storing the second predetermined information that has been input, and the second server includes an information acquisition part for acquiring the second predetermined information that has been stored in the second information storage part of the first server at a predetermined timing, and a database construction part for constructing a predetermined database on the basis of the second predetermined information that has been acquired.

In the second double-server system of the present invention, the first server connected to the first network provides the first predetermined information stored in the first information storage part to the first network, and the second predetermined information transmitted from the client computer through the first network is input and stored. The second server connected to the second network acquires the second predetermined information stored in the first server at a predetermined timing and constructs a predetermined database on the basis of the second predetermined information that has been acquired. Since the second server is not connected to the first network, a predetermined database that has been constructed can be prevented from being falsified by an illegal access from the first network. In other words, high security of the constructed database can be achieved.

As an aspect, in the second double-server system of the present invention, the second server can further comprises: an information conditioning part for conditioning the first predetermined information from the predetermined database that has been constructed; and an information outputting part for outputting the first predetermined information that has been conditioned to the first server so that the first predetermined information is stored in the first information storage part of the first server. As another aspect, the information acquisition part can be designed to acquire the second predetermined information at predetermined intervals with predetermined timing, or can be designed to delete acquired information from the second information storage part when the second predetermined information is acquired from the second information storage part. As still another aspect, the first server can have a firewall for the first network, the second server can have a firewall for the first server, the first network can be the Internet, and the second network can be an intranet. Additionally, as still another aspect, the first predetermined information can be defect-correcting information concerning the correction of a defect caused on the basis of the use of commodities, and the second predetermined information can be practical-accomplishment information concerning the practical accomplishment of the correction of a defect that has occurred in commodities.

A method for gathering and providing information of the present invention includes the steps of (a) inputting and storing predetermined information that has been transmitted from a client computer through a first network by a first server connected to the first network, and (b) acquiring the predetermined information stored in the first server at a predetermined timing by a second server connected to a second network and constructing a database, and providing predetermined information to the second network by using the constructed database.

According to the information gathering/providing method of the present invention, the second server is not connected to the first network, and therefore a predetermined database that has been constructed can be prevented from being falsified by an illegal access from the first network. In other words, high security of the constructed database can be achieved.

As an aspect, in the information gathering/providing method of the present invention, the step (a) can be changed into a step of inputting predetermined information from a client connected to the first network through a firewall by the first server, and the step (b) can be changed into a step of acquiring predetermined informational from the first server through a firewall by the second server.

Instead of a structure of severs such as an information providing server, an information providing/gathering server, and an information management server or instead of the structures of the information providing method and the information gathering/providing method which have been mentioned above, the present invention can be made in the structure of a storage medium that stores a program according to which computer is caused to function as the information providing server, as the information providing/gathering server, and as the information management server of the present invention.

### BRIEF DESCRIPTION OF THE DRAWINGS

FIG. 1 is a schematic diagram showing the structure of a double-server system 30 that is an embodiment of the present invention.

FIG. 2 is a schematic diagram showing the structure of a first information-providing server 32.

FIG. 3 is a schematic diagram showing the structure of a second information-providing server 42.

FIG. 4 is a flowchart showing an example of a document-up processing routine performed by the first information-providing server 32.

FIG. 5 is an explanatory diagram showing an example of a document registration dialog.

FIG. 6 is an explanatory diagram showing an example of a user registration dialog.

FIG. 7 is an explanatory diagram showing an example of a product model registration dialog.

FIG. 8 is a flowchart showing an example of a document-download processing routine performed by the first information-providing server.

FIG. 9 is a flowchart showing an example of a document retrieval display processing routine performed when a list of documents that can be provided to a client that has logged in is displayed.

FIG. 10 is an explanatory diagram showing an example of a retrieval screen.

FIG. 11 is an explanatory diagram showing an example of a retrieval result display screen.

FIG. 12 is an explanatory diagram showing an example of a retrieval result display screen, which is formed for and is output to a user, different from the retrieval result display screen of FIG. 11.

FIG. 13 is a schematic diagram showing the structure of a double-server system 130 according to a second embodiment of the present invention.

FIG. 14 is a flowchart showing an example of defect information providing processing that is performed by a Web server.

FIG. 15 is a flowchart showing an example of repair practical-accomplishment information processing that is performed by the Web server 142.

FIG. 16 is an explanatory diagram showing an example of a login screen 160.

FIG. 17 is an explanatory diagram showing an example of a defect diagnosis screen 162.

FIG. 18 is an explanatory diagram showing an example of a repair practical-accomplishment report screen 166.

FIG. 19 is a flowchart showing an example of repair practical-accomplishment acquisition processing that is performed at a predetermined timing as an agent program 158.

FIG. 20 is a flowchart showing an example of defect diagnosis data addition processing that is performed at a predetermined timing as the agent program 158.

### DETAILED DESCRIPTION OF THE PREFERRED EMBODIMENTS

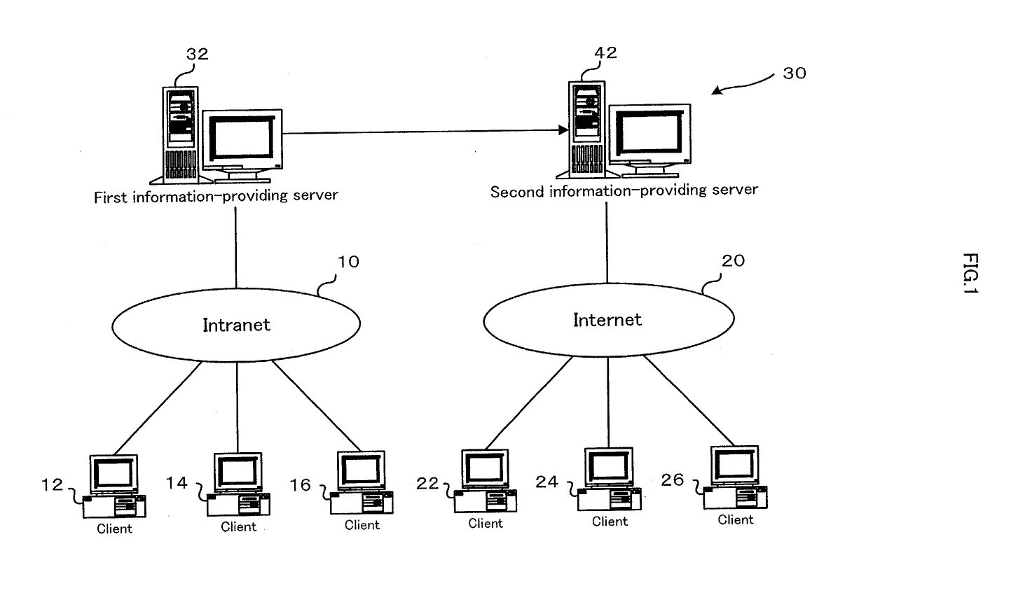

Preferred embodiments of the present invention will be described hereinafter. FIG. 1 is a schematic diagram showing the structure of a double-server system 30 that is an embodiment of the present invention. The double-server system 30 in this embodiment is made up of a first information providing server 32 that can provide information to an intranet 10 to which clients 12 to 16 are connected and a second information providing server 42 that can provide information to the Internet 20 to which clients 22 to 26 are connected. Information that is provided from the second information providing server 42 to clients 22 to 26 connected to the Internet 20 can be output from the first information providing server 32 to the second information providing server 42. In the double-server system 30 in this embodiment, a description is given on the supposition that document information, which consists of documents and information annexed to the documents, is provided from the first information providing server 32 or the second information providing server 42 to the intranet 10 or the Internet 20.

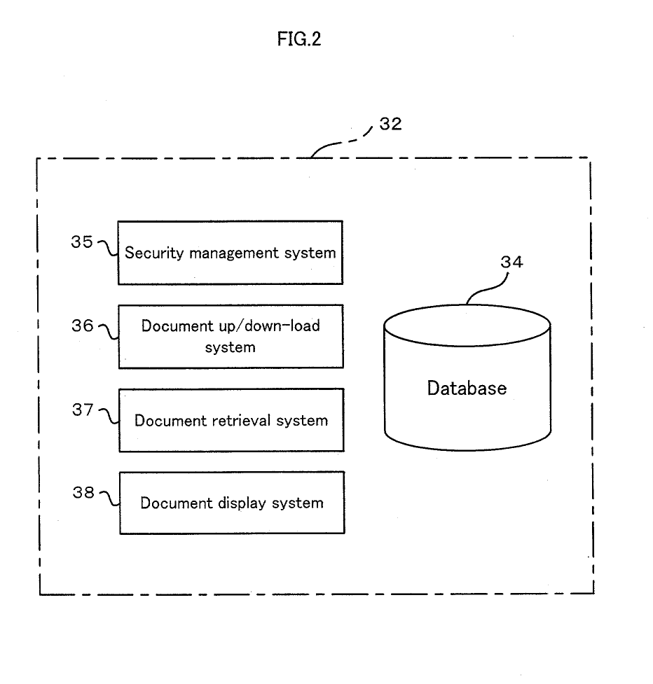

FIG. 2 is a schematic diagram showing the structure of the first information-providing server 32. As shown in the figure, the first information providing server 32 is basically made up of a database 34 for storing document information in a data base form, a security management system 35 for establishing an access right to documents, an access right for clients 12 to 16 having access to the first information providing server 32 through the intranet 10 and an access right for clients 22 to 26 having access to the second information providing server 42 through the Internet 20, a document up/down-load system 36 for uploading documents to the database 34 and downloading documents to the second information providing server 42, a document retrieval system 37 for retrieving documents stored in the database 34 in accordance with a demand from clients 12 to 16, and a document display system 38 for displaying and outputting a list of retrieved documents or documents selected from the document list to the side of clients 12 to 16. In the embodiment, the security management system 35, the document up/down-load system 36, the document retrieval system 37, and the document display system 38 are realized by a hardware structure and software. These systems do not each have individual hardware structure. Therefore, in some cases, the systems work independently of each other, and, in some cases, work in cooperation with each other.

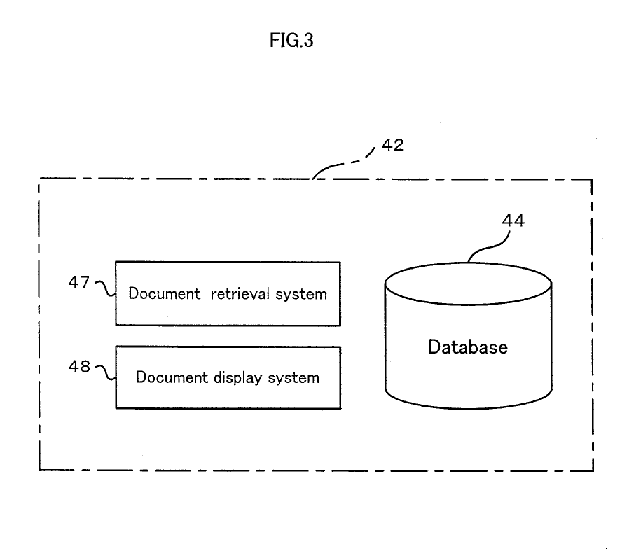

FIG. 3 is a schematic diagram showing the structure of the second information-providing server 42. As shown in the figure, the second information providing server 42 is basically made up of a database 44 for storing document information that has been downloaded from the first information providing server 32 in a database form, a document retrieval system 47 for retrieving documents stored in the database 44 in accordance with a demand from clients 22 to 26, and a document display system 48 for displaying and outputting a list of retrieved documents or documents selected from the document list to the side of clients 22 to 26.

Each of the first and second information providing servers 32 and 42 of the double-server system 30 in this embodiment may be formed of a plurality of computers or may be formed of a single computer. This derives not from a visual appearance matter but from a functional matter. This means that the server can function as a plurality of computers having a plurality of CPUs inside, and, if it is a single unit in appearance, it can be regarded as a plurality of computers or as a single computer.

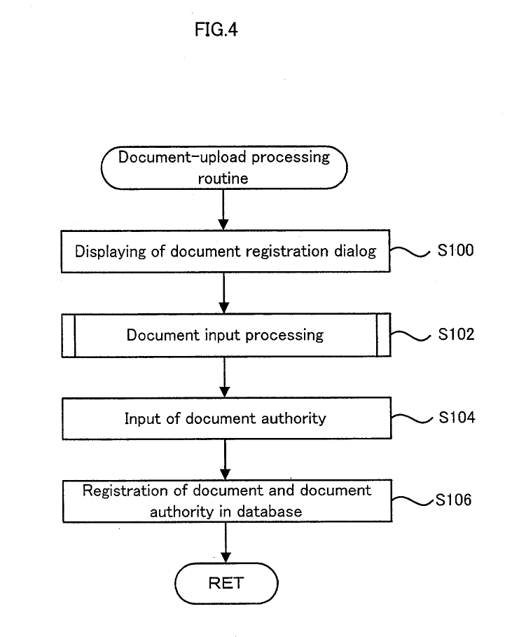

Next, a description will be given of the operation of the thus constructed double-server system 30 and, especially, processing that is performed in the security management of documents that have been uploaded to the database 34 of the first information providing server 32, in the downloading of document information to the second information providing server 42, and in the provision of document information from the first and second information providing servers 32 and 42 to the intranet 10 and to the Internet 20. FIG. 4 is a flowchart showing an example of a document-up processing routine performed by the first information-providing server 32 when documents are uploaded to the database 34 of the first information providing server 32. This routine is performed when a client authorized to upload a document to the first information-providing server 32 selects document-up processing.

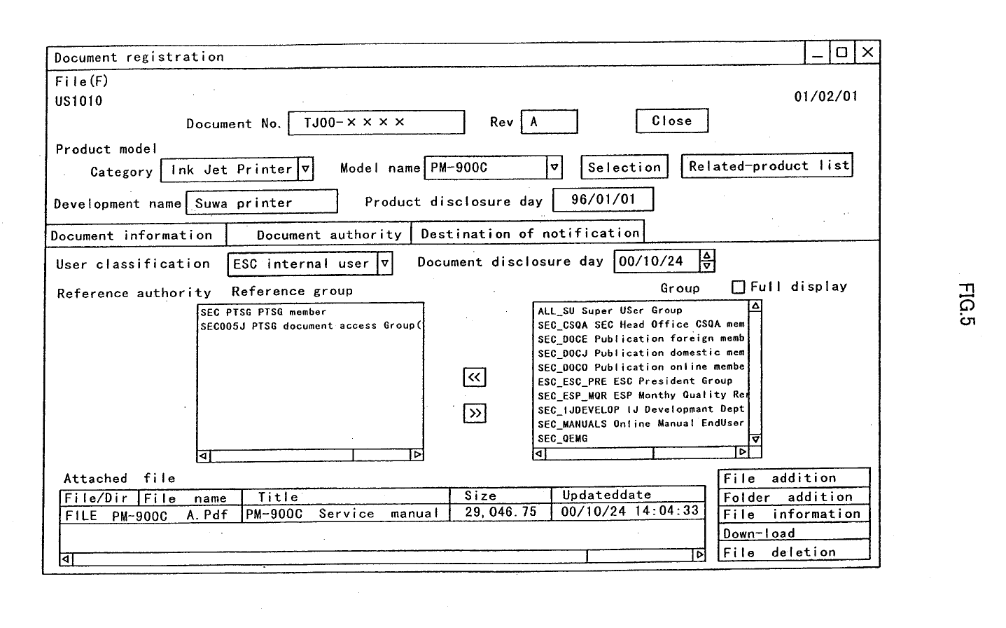

When this document-up processing routine is performed, the first information providing server 32 first displays a document registration dialog to the side of the client that has selected the document-up processing (Step S100), and performs document input processing (Step S102). An example of the document registration dialog is shown in FIG. 5. The document registration dialog of FIG. 5 shows a state in which the document input processing is completed, and document authority is in the process of being input. The document input processing is performed such that, in the document registration dialog, data is directly input to the input boxes of “Document No.” and “Rev” of “File” and to the input boxes of “Category” and “Model Name” of “Product Model” or, alternatively, data is input according to a pull-down menu, and, at the same time, the tag of “Document Information” is selected to input various information. Since the essence of the present invention resides not in the document input processing but in the structure of the double-server system 30 and the document authority, a further detailed description of the document input processing is omitted to avoid redundancies.

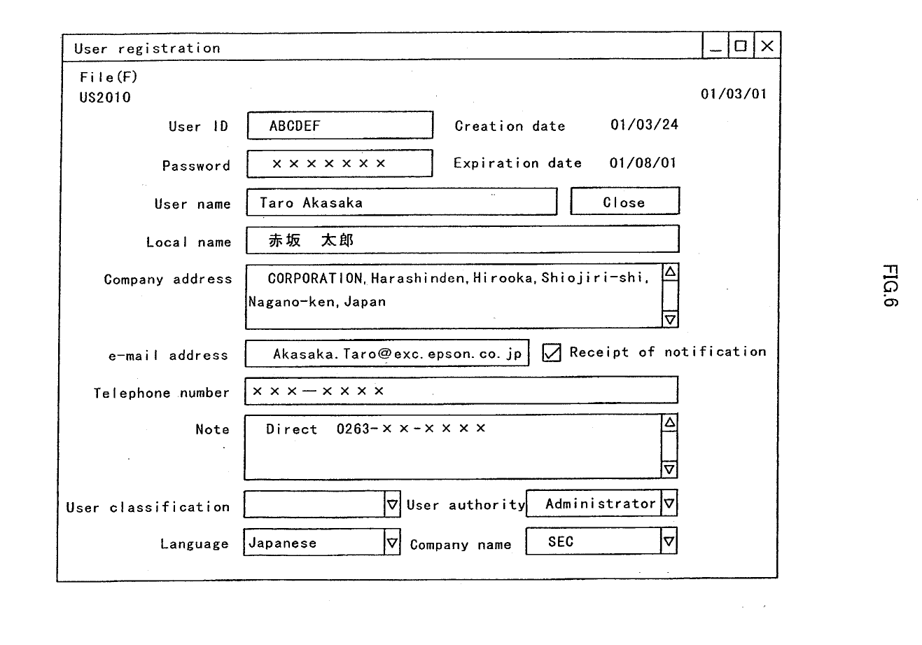

When the document input processing is completed, the input processing of the document authority is performed (Step S104). In the example of the document registration dialog of FIG. 5, the document authority is input such that the tag of “Document Authority” is selected, and data is input to the input boxes of “User Classification”, “Document Disclosure Day”, and “Reference Group” by selecting items in the pull-down menu or items in the list. Herein, “User Classification” is a broad classification of users (i.e., clients) that have access to the first and second information providing servers 32 and 42 through the intranet 10 or the Internet 20. In this embodiment, clients of the intranet 10 are hierarchized into system management users who can carry out system management and intranet users other than the system management users, whereas the clients of the Internet 20 are hierarchized as Internet users that have access to the second information providing server 42. Both the classification with respect to the intranet 10 and the classification with respect to the Internet 20 can be merely made by selection according to the pull-down menu. “Reference Group” is a sub-classification used to further hierarchize the users (clients) who belong to an item selected by “User Classification”, and is input by selecting an item of the list appearing on the right of the figure. Through the selection in “User Classification” and “Reference Group”, an access right, which is permission to display this document, can be established by use of the broad classification and sub-classification. In this embodiment, a user is registered for whom a user ID, for example, is given by use of a user registration dialog displayed by a user registration processing routine not shown in the figure. An example of the user registration dialog is shown in FIG. 6. In the user registration dialog of FIG. 6, items to be input for the registration of a user are user classification, user authority, language, company name, and so on, in addition to password, user name, local name, company address, e-mail address, and telephone number. In this user registration dialog, groups (sub-classification) that can be selected for a reference group are classified according to the user classification. Access rights other than the document display permission, such as permission to upload a document, establishment of an access right, and change permission, are selected from the pull-down menu and are input to the input box of “User Authority”. In this embodiment, a system management user in the broad classification of the intranet 10 is set as an “administrator” who has an access right by which a document can be uploaded or the document authority of all documents can be established or changed. An intranet user other than “administrator” is set as a person who has an access right by which a document can be uploaded within a range of access rights established by the system management user or by which the setting and change with respect to an Internet user with document authority over the document uploaded by the intranet user can be performed. An Internet user is set as a person who can display a document through the Internet 20 within a range where an access right is established by the system management user and the intranet user. The day to be input for “Document Disclosure Day” is a day when an input document begins disclosure to a client having access through the intranet 10 or the Internet 20.

The document authority is input in this way, and, when the document registration dialog is closed by selecting the button “Close”, data concerning the input document or the document authority is stored in the database 34 (Step S106), and this routine is ended. The document is uploaded, and the access right and the disclosure day concerning the document are registered in the database 34 in this way.

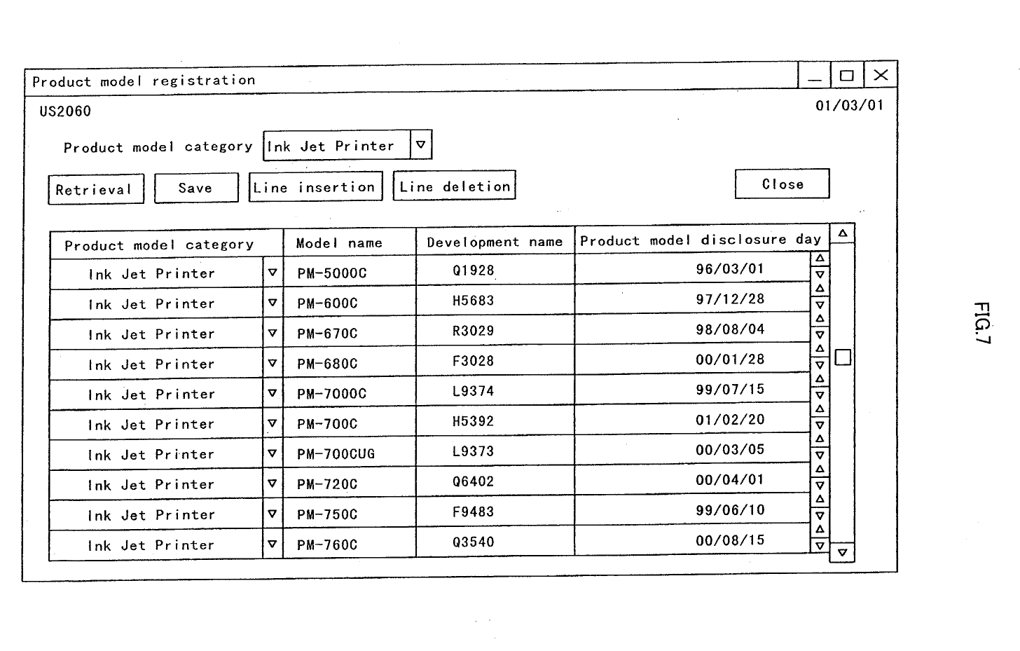

In the document registration dialog of FIG. 5, the disclosure day of the product model is displayed in “Product Disclosure Day” when “Model Name” of “Product Model” is selected from the pull-down menu. This product model disclosure day is input from a product model registration dialog displayed by a product model registration processing routine not shown in the figure. An example of the product model registration dialog is shown in FIG. 7. In the product model registration dialog of FIG. 7, the product model disclosure day of each product model can be input.

When the disclosure day and the access right are registered in the database 34 together with each document, the access right in the document is judged on the basis of user ID input by a client accessing the first information providing server 32 through the intranet 10 when logging in. Accordingly, the displaying, writing, etc., of document information are permitted on the basis of a range of access rights that have been determined. The range of access rights of system management users, intranet users, and Internet users have been mentioned above.

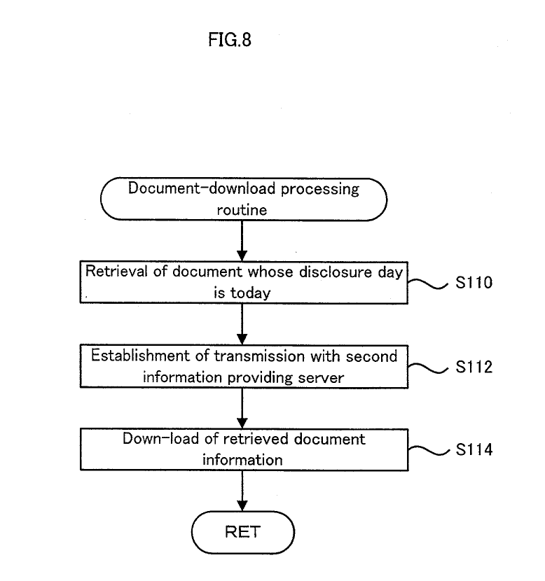

Next, a description will be given of processing performed when a document registered in the database 34 of the first information providing server 32 is downloaded to the database 44 of the second information providing server 42. FIG. 8 is a flowchart showing an example of a document-download processing routine performed by the first information-providing server 32. This routine is performed at a predetermined time (e.g., 10 a.m.) each day.

In performing the document-download processing routine, the first information providing server 32 first accesses the database 34, then retrieves document information whose document disclosure day is today among the registered document information (Step S110), and performs processing for establishing communication with the second information providing server 42 (Step S112). Thereafter, the document information that has been retrieved as information whose document disclosure day is today is output to the second information providing server 42, i.e., is downloaded thereto (Step S114), and the routine is ended. The second information providing server 42 registers the document information output from the first information-providing server 32 into the database 44. An access right (document authority) as well as a document is included in document information to be downloaded to the second information-providing server 42. In the document-download processing routine in this embodiment, the document information whose document disclosure day is today is retrieved from among all document information, the processing for establishing communications with the second information providing server 42 is then performed, and the retrieved document information is downloaded. However, since the communications with the second information-providing server 42 can be established before downloading, it may be established before or after the retrieval of the document information.

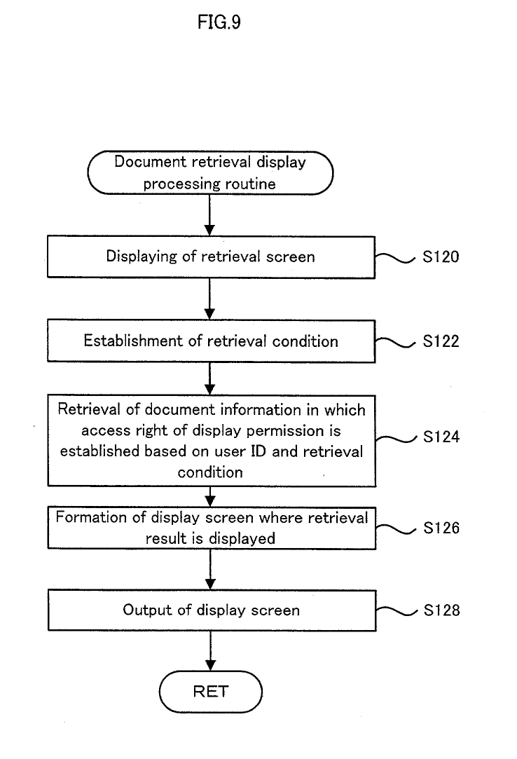

Next, a description will be given of processing for providing the document information registered in the databases 34 and 44 to clients. FIG. 9 is a flowchart showing an example of a document retrieval display processing routine performed when a list of documents that can be provided to a client that has logged in is displayed. This routine is performed when clients 12 to 16 or clients 22 to 26 log into a document information providing site provided by the first or second information-providing server 32 or 42 through the intranet 10 or the Internet 20.

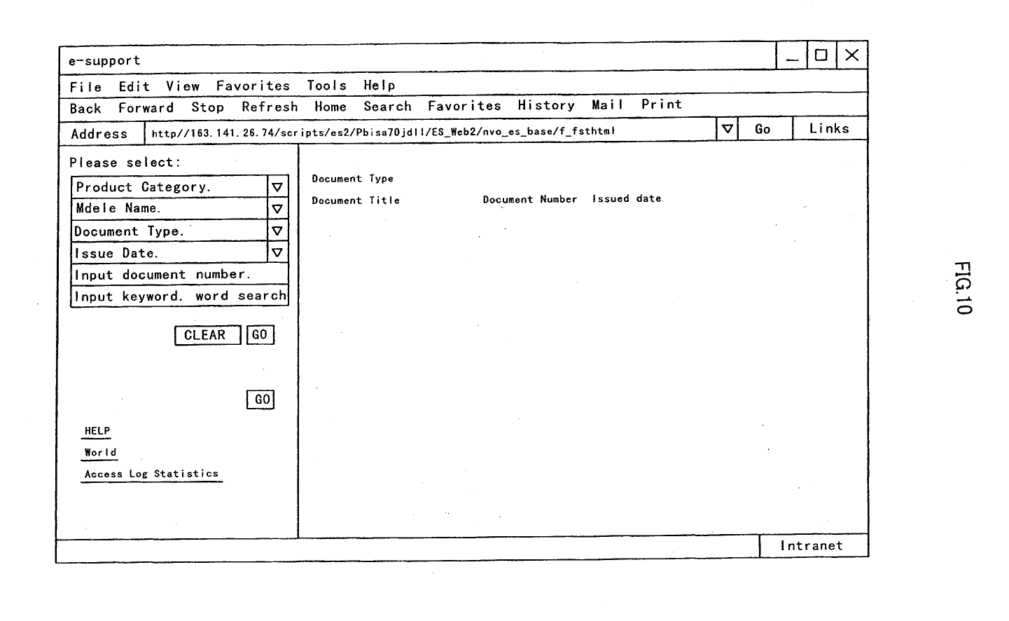

In performing this document retrieval display processing routine, the first and second information providing servers 32 and 42 first display a retrieval screen (Step S120), and then perform processing for establishing a retrieval condition (Step S122). FIG. 10 shows an example of the retrieval screen. In the retrieval screen of FIG. 10, the retrieval condition is input by selecting a desired product model category and model name from the pull-down menu and by inputting it to the input box of “Product Category” or “Model Name” appearing on the left of the figure. When the retrieval condition is input, and the button “GO” is selected, document information in which the access right of display permission has been established is retrieved from the database 34 or the database 44 on the basis of the user ID input when the user logs in and on the basis of the input retrieval condition (Step S124). When the document information is retrieved from the database 34 of the first information providing server 32, a document disclosure day established concerning the displaying of the document information is also retrieved as a retrieval condition, based on the access right established for a user. Therefore, in the case of a user who has only an access right for which document information which has not reached the document disclosure day cannot be displayed, only document information which has reached the document disclosure day is retrieved. When the document information is retrieved from the database 44 of the second information-providing server 42, the document information is downloaded to the database 44 at a predetermined time of the document disclosure day. Therefore, all document information registered in the database 44 has reached the document disclosure day, and there is no need to set the document disclosure day as a retrieval condition.

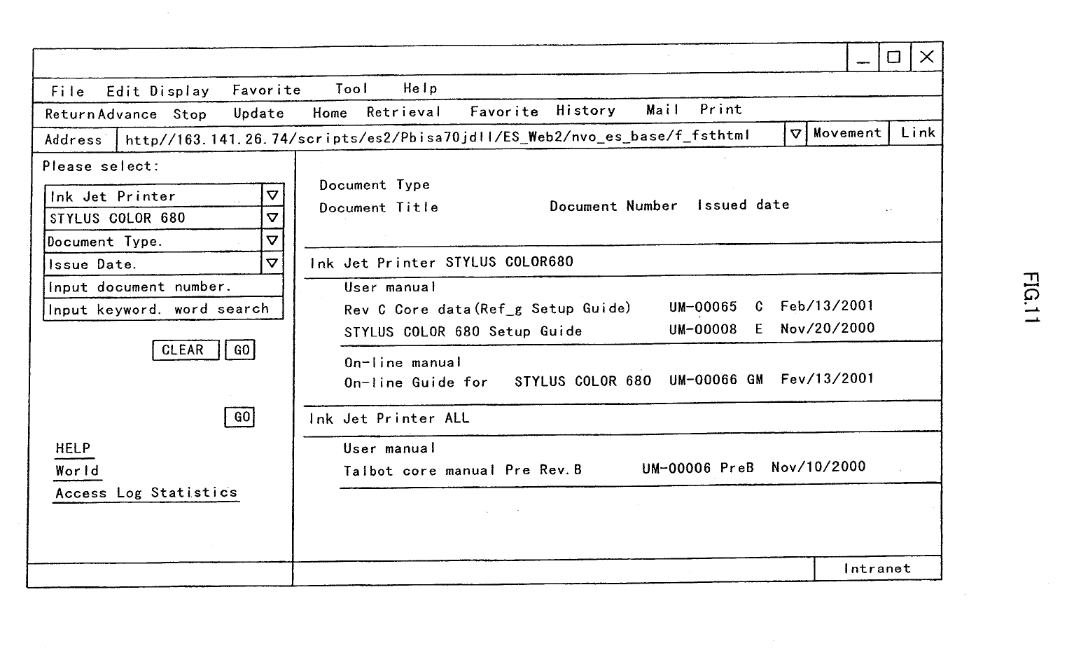

Thereafter, a display screen (retrieval result display screen) to display a retrieval result is formed (Step S126), the formed retrieval result display screen is then output to the side of a client (Step S128), and this routine is ended. Since the retrieval result depends on an access right or a document disclosure day to be established, the retrieval result display screen is formed each time and is output to the client side. FIG. 11 and FIG. 12 each show an example of the retrieval result display screen that is formed for and is output to different users. As shown in the figures, different retrieval results are obtained for users who have different access rights in spite of the fact that information is retrieved by using the same model name under the same product model category. Therefore, different retrieval result display screens are displayed.

According to the double-server system 30 in this embodiment described above, document information can be provided to clients 12 to 16 having access the first information providing server 32 through the intranet 10, based on the access rights established for the documents and for the users and based on the document disclosure day established for each document. Further, based on the access rights established for the documents and for the users, document information can be provided to clients 22 to 26 having access to the second information providing server 42 through the Internet 20. Moreover, since document information is downloaded from the first information providing server 32 to the second information providing server 42 at a predetermined time of the document disclosure day, document information that has not reached the document disclosure day can be prevented from being provided by an illegal access to the second information providing server 42. In other words, high security can be achieved.

Further, according to double-server system 30 in this embodiment, clients 12 to 16 can be hierarchized by establishing the access rights for clients 12 to 16 having access to the first information providing server 32 through the intranet 10, and clients 22 to 26 can be hierarchized by establishing the access rights for clients 22 to 26 having access to the second information providing server 42 through the Internet 20. Moreover, both the access rights for clients 12 to 16 having access to the first information providing server 32 and the access rights for clients 22 to 26 having access to the second information providing server 42 can be uniformly established by using the document registration dialog. Therefore, the access rights for clients 22 to 26 do not need to be established in the second information providing server 42.

Further, according to the double-server system 30 in this embodiment, a display screen that users having different access rights can comfortably see can be displayed since a retrieval result display screen is formed whenever displayed.

As described above, in the double-server system 30 in this embodiment, a system management user in the broad classification of the intranet 10 is set as an “administrator” who has an access right by which a document can be uploaded or the document authority of all documents can be established or changed, and an intranet user other than the administrator is set as a person who has an access right by which a document can be uploaded within a range of access rights established by the system management user or by which the setting and change with respect to an Internet user of the document authority over the document uploaded by the intranet user can be performed, and, in addition, an Internet user is set as a person who can display a document through the Internet 20 within a range where an access right is established by the system management user and the intranet user. However, without being limited to these access rights, the present invention can establish various access rights.

In the double-server system 30 in this embodiment, both the product model disclosure day of a product model and the document disclosure day of a document are established. Instead, only the document disclosure day of a document maybe established. Further, although the document disclosure day of a document is established in the double-server system 30 in this embodiment, establishment is not necessarily based on the day, and may be based on the date and time, i.e., the document disclosure date and time may be established. In this case, document information from the first information providing server 32 to the second information providing server 42 should be downloaded at the document disclosure date and time.

In the double-server system 30 in this embodiment, access rights to a document are established according to a user classification as a broad classification and according to a reference group as a sub-classification that are used to establish document authority. Instead, rights may be established according to each user. Additionally, an access right by which only a part of document information can be displayed may be established as document authority.

In the double-server system 30 in this embodiment, a retrieval result display screen is formed and displayed each time. Instead, a retrieval result may be displayed by use of a retrieval result display screen having a predetermined format.

In the double-server system 30 in this embodiment, document information is provided from the first and second information providing servers 32 and 42 to the intranet 10 and to the Internet 20. However, information other than the document information may be provided.

As mentioned above, the double-server system 30 in this embodiment is made up of the first information providing server 32 that provides information to clients 12 to 16 connected to the intranet 10 and the second information providing server 42 that provides information to clients 22 to 26 connected to the Internet 20. However, since what is necessary is that the network that provides information from the first information providing server 32 differs from the network that provides information from the second information providing server 42, the present invention is not limited to the intranet and the Internet.

The double-server system 30 has been described as one preferred embodiment of the present invention. However, it may be the first information providing server 32 in the double-server system 30 in this embodiment. Further, it may be a storage medium for storing a program that causes the computer to function as the first information providing server 32 in the double-server system 30 or a program that causes the computer to function as the second information providing server 42 in the double-server system 30. If it is a storage medium that stores a program that causes the computer to function as the first or second information providing server 32 or 42, the processing with respect to the first or second information providing server 32 or 42 among the aforementioned processings should be described by a suitable programming language at each step and be stored on, for example, a CD-ROM.

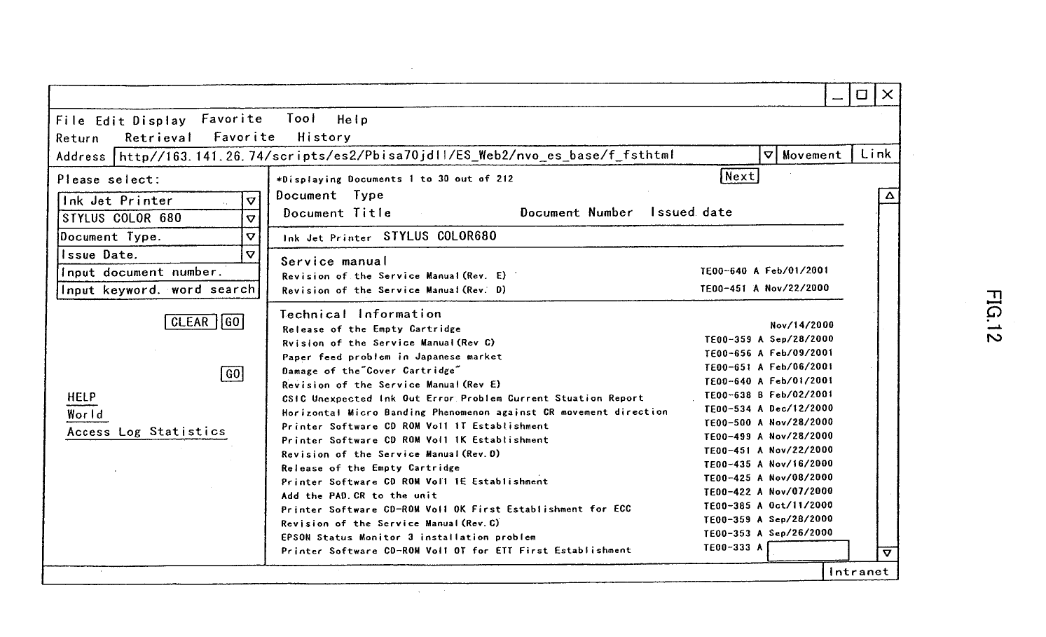

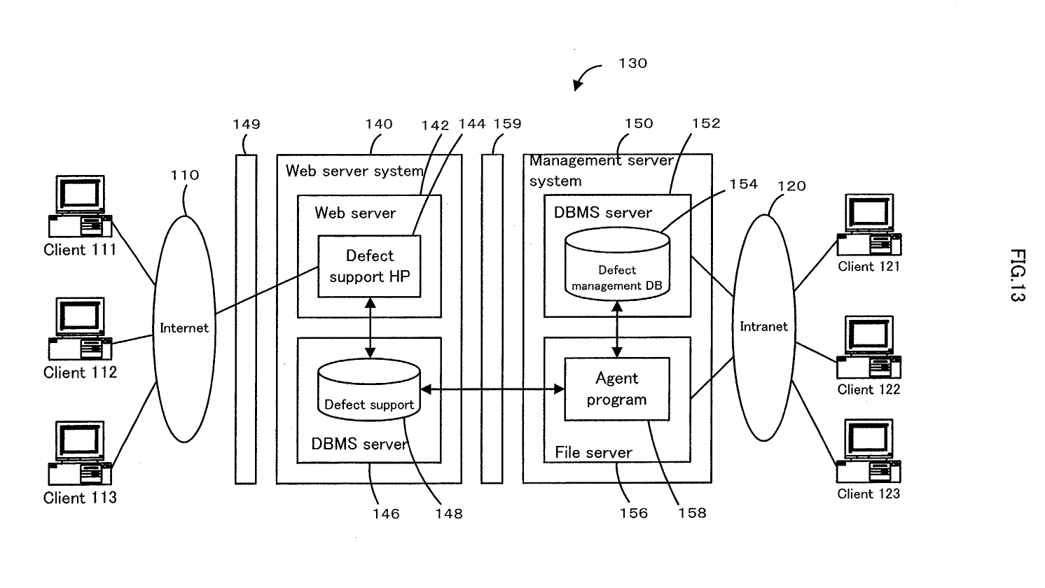

Next, a description will be given of a second preferred embodiment of the present invention. FIG. 13 is a schematic diagram showing the structure of a double-server system 130 according to the second embodiment of the present invention. As shown in the figure, the double-server system 130 in this embodiment is made up of a Web server system 140 connected to the Internet 110 and a management server system 150 connected to the intranet 120.

The Web server system 140 includes a Web server 142 for showing a defect support homepage 144 used to support the defect of a commodity to clients 111 to 113 to whom access rights are given through the Internet 110 and a DBMS server 146 for constructing a defect support database 148 used to provide, to the defect support homepage 144, defect diagnosis data for eliminating a defect that is presented to clients 111 to 113 by the defect support homepage 144 or used to gather repair practical-accomplishment data about a defect that is input from clients 111 to 113 through the defect support homepage 144 and store the data. In order to achieve security from the Internet 110 side, Access to the Web server 142 through the Internet 110 by clients 111 to 113 is performed via a known firewall 149.

The management server system 150 includes a DBMS server 152 for constructing a defect management database 154 used to manage information about the defect of a commodity and a file server 156 for executing an agent program 158 for gathering and providing data by accessing the defect management database 154 and the defect support database 148 at a predetermined timing. The DBMS server 152 and the file server 156 are connected to the intranet 120 and are designed to allow clients 121 to 123 to read or write data within a range of access rights. In order to achieve the security from the Internet 110 side, the agent program 158 accesses the defect support database 148 through a known firewall 159.

The hardware structure of the double-server system 130 in the second embodiment is created as described above. For convenience, the Web server system 140 and the management server system 150 have been each described as including two servers. However, as a basic concept, they are identical to the Web server system 140 formed of a single server that has both the function of the Web server 142 and that of the DBMS server 146 and the management server system 150 formed of a single server that has both the function of the DBMS server 152 and that of the defect management database 154, respectively. In other words, in this embodiment, the two servers of the present invention correspond to the web server system 140 and the management server system 150. Thus, whether the Web server system 140 and the management server system 150 are each constructed as a single server or as a server comprised of a plurality of servers depends on the performance of a computer to be used. Therefore, this is not essential to the present invention.

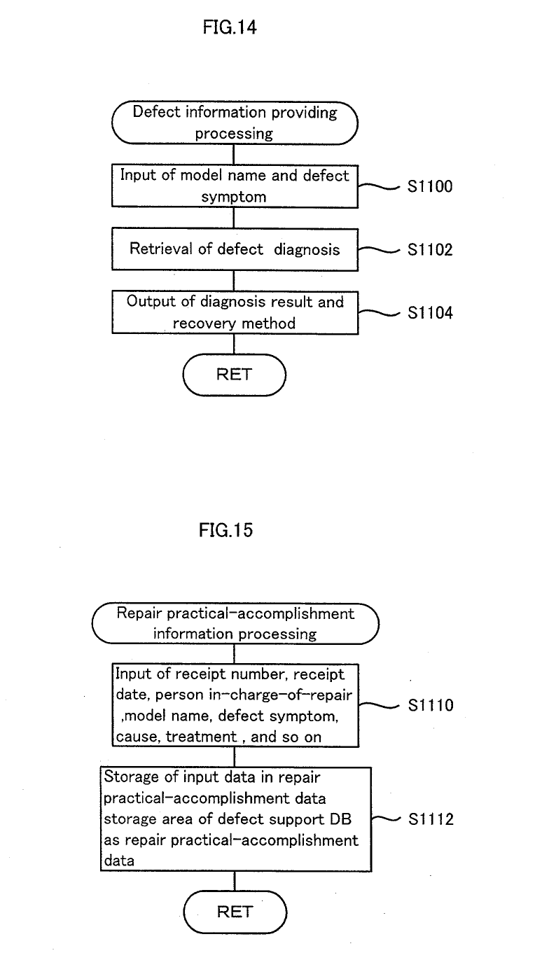

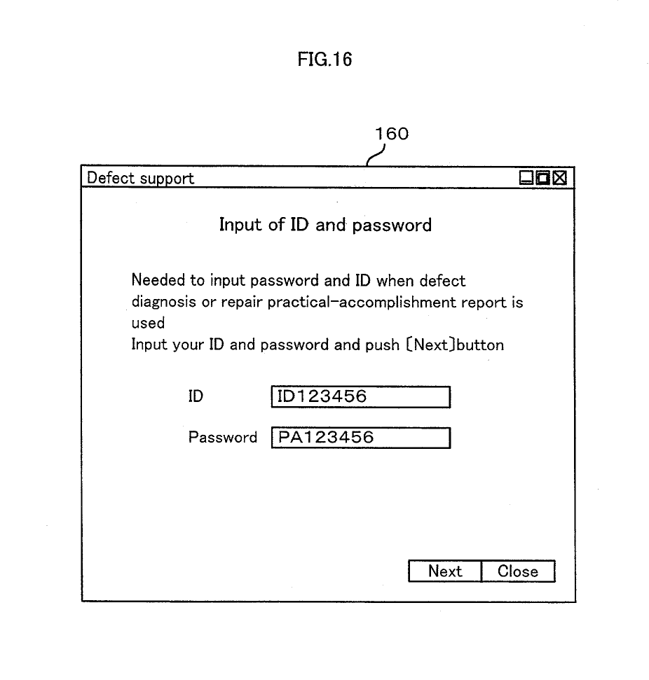

Next, a description will be given of the operation of the double-server system 130 in the second embodiment constructed as above. FIG. 14 is a flowchart showing an example of defect information providing processing that is performed by the Web server 142 when defect information is provided to clients 111 to 113, and FIG. 15 is a flowchart showing an example of repair practical-accomplishment information processing that is performed by the Web server 142 when information concerning a repair practical-accomplishment is gathered from clients 111 to 113. The defect information providing processing and the repair practical-accomplishment information processing are performed by use of the defect support homepage 144 that the Web server 142 provides to clients 111 to 113 by inputting an ID and a password to a login screen 160 of FIG. 16.

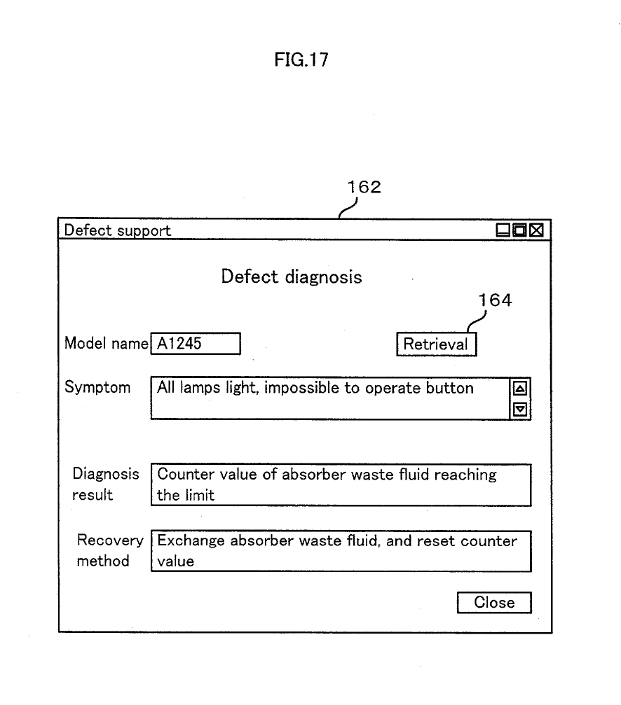

In the defect information providing processing, the Web server 142 first displays and outputs a defect diagnosis screen 162 of FIG. 17 and performs processing for inputting a model name of a product where a defect appears and its symptom (Step S1100). In the example of FIG. 17, the model name and the symptom can be input beforehand by prepared options. When the model name and the symptom are selected and input from a client, and when a [Retrieval] button 164 is pushed, a diagnosis result of the defect and a recovery method are retrieved on the basis of the model name and the symptom (Step S1102), thereafter the diagnosis result and the recovery method are output and displayed on a display part of the defect diagnosis screen 162 (Step S104), and this processing is ended. The defect diagnosis screen 162 in this embodiment is designed so as to perform the procedure that follows Step S1102 of the defect information providing processing shown in FIG. 14 by inputting another model name or another symptom and pushing the [Retrieval] button 164 from a state in which the diagnosis result and the recovery method are input and displayed, thereby making it possible to find another model name and treat its symptom successively. By performing the processing in this way, the Web server system 140 provides various information about the defect of a product model to clients 111 to 113.

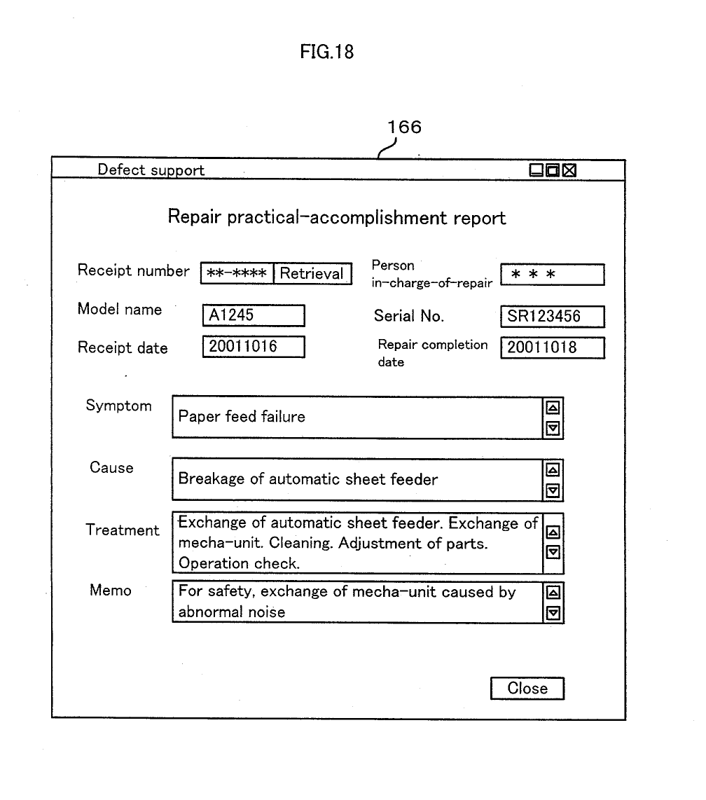

In the repair practical-accomplishment processing, the Web server 142 first outputs and displays a repair practical-accomplishment report screen 166 shown in FIG. 18, and then performs processing for inputting practical accomplishments to the input boxes of receipt number, in-charge-of-repair person, model name, serial number, receipt date, repair completion date, symptom, cause, treatment, and memo (Step S1110). In the screen 166 in this embodiment, an item can be selected from contents that have been prepared beforehand and be input to the input boxes of the symptom, cause, and treatment. Additionally, if contents differing from the prepared ones need to be input, they can be freely input. When a repair practical-accomplishment is input from a client, the input practical-accomplishment is stored in a form of repair practical-accomplishment data in a repair practical-accomplishment data storage area provided in the defect support database 148 (Step S1112), and this processing is ended. Through this repair practical-accomplishment processing, the Web server system 140 can gather the repair practical-accomplishments of product models from clients 111 to 113. In this embodiment, when the input practical-accomplishment is stored in a form of repair practical-accomplishment data in the repair practical-accomplishment data storage area provided in the defect support database 148, the repair practical-accomplishment data is stored as a text. Instead, a database by the repair practical-accomplishment data may be constructed.

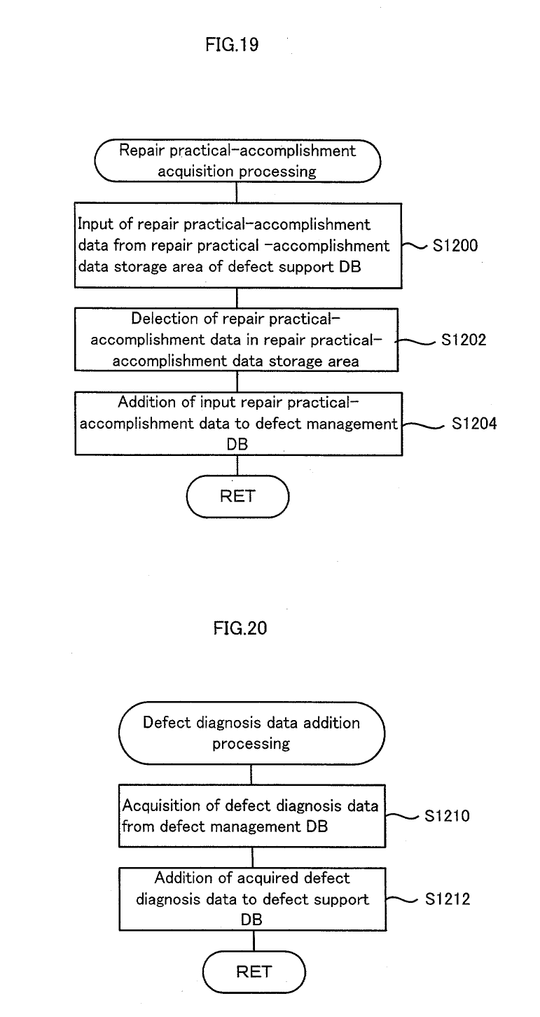

FIG. 19 is a flowchart showing an example of repair practical-accomplishment acquisition processing that is performed at a predetermined timing (e.g., at 0 a.m. each day) as the agent program 158 of the file server 156, and FIG. 20 is a flowchart showing an example of defect diagnosis data addition processing that is performed at a predetermined timing (e.g., at 1 a.m. on Monday) as the agent program 158.

In the repair practical-accomplishment acquisition processing, the agent program 158 first inputs the repair practical-accomplishment data from the repair practical-accomplishment data storage area of the defect support database 148 (Step S1200), and then performs processing for erasing the repair practical-accomplishment data from the repair practical-accomplishment data storage area (Step S1202). Thereafter, the input repair practical-accomplishment data is added to the defect management database 154 of the DBMS server 152 (Step S1204), and this processing is ended. Through this processing, the management server system 150 can add the repair practical-accomplishment data that has been input from clients 111 to 113 to the defect management database 154, i.e., can gather repair practical-accomplishments. Moreover, since the management server system 150 is connected to the Internet 110 only through the firewall 149, the Web server system 140, and the firewall 159, data can be prevented from being falsified by an illegal approach such as hacking. The defect management database 154 can provide various data that includes the repair practical-accomplishment data to clients 121 to 123 connected to the intranet 120, and can compile the repair practical-accomplishment data and other data on the basis of access rights. The repair practical-accomplishment data gathered in this way is analyzed by, for example, clients 121 to 123, thereafter is transformed into defect diagnosis data, and is added to the defect management database 154.

In the defect diagnosis data addition processing, the agent program 158 first performs processing to acquire, from the defect management database 154, the defect diagnosis data that has been adjusted by clients 121 to 123 and has been added to the defect management database 154 (Step S1210). Thereafter, the acquired defect diagnosis data is added to the defect support database 148 of the DBMS server 146 (Step S1212), and this processing is ended. Through this processing, a symptom, a diagnosis result, and a recovery method are added which are obtained from a defect diagnosis made by use of the defect diagnosis screen 162 of FIG. 17 by clients 111 to 113, and, as a result, more proper information can be provided to clients 111 to 113.

According to this double-server system 130 in the second embodiment as described above, information concerning the defect of a product is provided to clients 111 to 113 by the Web server system 140 connected to the Internet 110 through the firewall 149, and repair practical-accomplishments are gathered from clients 111 to 113. Additionally, repair practical-accomplishments gathered at the Web server system 140 are acquired by the management server system 150 connected to Web server system 140 through the firewall 159, and the defect diagnosis data adjusted on the basis of the repair practical-accomplishments is provided to the Web server system 140. Therefore, an illegal approach to the management server system 150 from the Internet 110 can be prevented with high security. As a result, the falsification of data in the management server system 150 can be avoided with high security.

As mentioned above, in the double-server system 130 in the second embodiment, the repair practical-accomplishment acquisition processing is performed at the timing of 0 a.m. each day, and the defect diagnosis data addition processing is performed at the timing of 1 a.m. on Monday every week. However, the execution timing of the repair practical-accomplishment acquisition processing or the execution timing of the defect diagnosis data addition processing is not limited to a specific one.

As mentioned above, in the double-server system 130 in the second embodiment, the repair practical-accomplishment data acquired when the repair practical-accomplishment data is acquired from the defect support database 148 is erased. Instead, the data may not be erased.

Further, in the double-server system 130 in the second embodiment, the provision of information concerning the defect of a product and the gathering of repair practical-accomplishments have been exemplified. However, any information can be provided from the Web server system 140 without being limited to the defect information, and any information can be gathered at the Web server system 140 without being limited to the repair practical-accomplishments.

As mentioned above, in the double-server system 130 in the second embodiment, the Internet 110 is connected to the Web server system 140 through the firewall 149, and the intranet 120 is connected to the management server system 150. However, any network can be connected to the Web server system 140 without being limited to the Internet, and any network can be connected to the management server system 150 without being limited to the intranet.

In the double-server system 130 in the second embodiment, the DBMS server 146 and the DBMS server 152 are used to use the DBMS as a data management method. However, if a data management method other than this method is used, various types of servers, such as a file server that corresponds to a text, can be used.

The double-server system 130 comprised of the Web server system 140 and the management server system 150 has been described as one example of the preferred embodiments of the present invention. However, the present invention can employ various structures, such as a structure as the Web server system 140 or as the management server system 150, a structure of a storage medium that stores a program that causes a computer to function as the Web server system 140, and a structure of a storage medium that stores a program that causes a computer to function as the management server system 150. If it is a structure of a storage medium that stores a program that causes a computer to function as the Web server system 140, the defect information providing processing of FIG. 14 and the repair practical-accomplishment information processing of FIG. 15 can be each programmed with a suitable programming language and can be stored on, for example, a CD-ROM. If it is a structure of a storage medium that stores a program that causes a computer to function as the management server system 150, the repair practical-accomplishment acquisition processing of FIG. 19 and the defect diagnosis data addition processing of FIG. 20 can be each programmed with a suitable programming language and can be stored on, for example, a CD-ROM.

The present invention has been described with reference to the embodiments as above. However, without being limited to these embodiments, the present invention can be, of course, embodied in various structures within the range not departing from the spirit of the present invention.

What is claimed is:

1. An information providing server that can provide information to a first network, the information providing server comprising:
an information storage part for storing predetermined information;
an information providing part for providing the stored predetermined information to the first network;
a disclosure timing setting part for setting disclosure timing with respect to each of the predetermined information stored in the information storage part; and
an information outputting part for outputting information that has reached the disclosure timing set by the disclosure timing setting part among the predetermined information to a second information providing server that can provide information to a second network that differs from the first network.

2. An information providing server in accordance with claim 1, wherein
the disclosure timing setting part sets a disclosure day as the disclosure timing;
and the information outputting part outputs corresponding information when a predetermined time of the disclosure day as the disclosure timing is reached.

3. An information providing server in accordance with claim 1,
further comprising an access right establishing part for establishing access rights to a client having access through the first network and to the predetermined information,
wherein the information providing part provides information on the basis of the access rights established by the access right establishing part.

4. An information providing server in accordance with claim 3, wherein
the access right establishing part establishes prohibitions or permissions that include at least one of the prohibitions of access, permission of only reading, and permission of reading and writing.

5. An information providing server in accordance with claim 3, wherein
the access right establishing part establishes an access right to each client having access to the second information providing server through the second network.

6. An information providing server in accordance with claim 5, wherein
the access right establishing part establishes either prohibition of access or permission of only reading as the access right to each client having access to the second information providing server through the second network.

7. An information providing server in accordance with claim 1, wherein
the predetermined information is document information.

8. An information providing server in accordance with claim 1, wherein
the first network is an intranet; and
the second network is the Internet.

9. A storage medium storing a program that causes a computer to function as a server, the server being an information providing server that can provide information to a first network,
the server comprising: an information storage part for storing predetermined information; an information providing part for providing the stored predetermined information to the first network; a disclosure timing setting part for setting disclosure timing with respect to each of the predetermined information stored in the information storage part; and an information outputting part for outputting information that has reached the disclosure timing set by the disclosure timing setting part among the predetermined information to a second information providing server that can provide information to a second network that differs from the first network.

10. A double-server system comprising a first server capable of providing information to a first network and a second server capable of providing information to a second network,
the first server comprising: a first information storage part for storing predetermined information; a first information providing part for providing the stored predetermined information to the first network; a disclosure timing setting part for setting disclosure timing with respect to each of the predetermined information stored in the first information storage part; and an information outputting part for outputting information that has reached the disclosure timing set by the disclosure timing setting part among the predetermined information stored in the first information storage part to the second server;
the second server comprising: a second information storage part for storing information output from the information outputting part; and a second information providing part for providing the stored information to the second network.

11. An double-server system in accordance with claim 10, wherein
the disclosure timing setting part sets a disclosure day as the disclosure timing; and
the information outputting part outputs corresponding information when a predetermined time of the disclosure day as the disclosure timing is reached.

12. An double-server system in accordance with claim 10, wherein
the first server includes an access right establishing part for establishing access rights to a client having access to the first server through the first network and to the predetermined information; and
the first information providing part provides information on the basis of the access rights established by the access right establishing part.

13. An double-server system in accordance with claim 12, wherein
the access right establishing part establishes prohibitions or permissions that include at least one of the prohibitions of access, permission of only reading, and permission of reading and writing.

14. An double-server system in accordance with claim 12, wherein
the access right establishing part is a part that establishes an access right to each client having access to the second server through the second network; and
the second information providing part is a part that provides information stored in the second information storage part on the basis of the access right established by the access right establishing part.

15. An double-server system in accordance with claim 14, wherein
the access right establishing part establishes either a prohibition of access or permission of only reading as the access right to each client having access to the second server through the second network.

16. An double-server system in accordance with claim 10, wherein
the predetermined information is document information.

17. An double-server system in accordance with claim 10, wherein
the first network is an intranet; and
the second network is the Internet.

18. A method for providing information to a first network and to a second network, the method comprising the steps of:
(a) storing predetermined information in a first server that can provide information to the first network and providing the predetermined information to the first network,
(b) setting disclosure timing with respect to the predetermined information stored in the first server, and
(c) storing the predetermined information in a second server that can provide information to the second network and providing the information to the second network when the set disclosure timing is reached.

19. An information providing/gathering server that is connected to a first network and that provides and gathers information, the information providing/gathering server comprising:
a first information storage part for storing first predetermined information;
an information providing part for providing the first predetermined information that has been stored therein to the first network;
an information inputting part for inputting second predetermined information that has been transmitted from a client computer through the first network;
a second information storage part for storing the second predetermined information that has been input; and
an information outputting part for, when a request from a host computer connected to a second network different from the first network is received to output the second predetermined information that has been stored in the second information storage part under a predetermined condition, outputting the second predetermined information to the host computer.

20. An information providing/gathering server in accordance with claim 19, wherein
the first information storage part stores the input information as the first information when information that has been adjusted on the basis of the second predetermined information is input from the host computer.

21. An information providing/gathering server in accordance with claim 19, further comprising a firewall having a security function for the first network.

22. An information providing/gathering server in accordance with claim 19,
the first network is the Internet; and
the second network is an intranet.

23. An information providing/gathering server in accordance with claim 19,
the first predetermined information is defect-correcting information concerning a correction of a defect caused on the basis of the use of commodities; and
the second predetermined information is practical-accomplishment information concerning a practical accomplishment of a correction of a defect that has occurred in commodities.

24. A storage medium storing a program that causes a computer to function as a server, the server being an information providing/gathering server that is connected to a first network and that provides and gathers information,
the server comprising: a first information storage part for storing first predetermined information; an information providing part for providing the first predetermined information that has been stored therein to the first network; an information inputting part for inputting second predetermined information that has been transmitted from a client computer through the first network; a second information storage part for storing the second predetermined information that has been input; and an information outputting part for, outputting the second predetermined information to the host computer when a request from a host computer connected to a second network different from the first network is received to output the second predetermined information that has been stored in the second information storage part under a predetermined condition.

25. An information management server that manages a predetermined server connected to a first network and that gathers the second predetermined information from the first network in accordance with provisions of the first predetermined information, the information management server being connected to a second network different from the first network, the information management server comprising:
an information acquisition part for acquiring the second predetermined information that has been gathered by the predetermined server at a predetermined timing; and
a database construction part for constructing a predetermined database on the basis of the second predetermined information that has been acquired.

26. An information management server in accordance with claim 25, further comprising:
an information conditioning part for conditioning the first predetermined information from the predetermined database that has been constructed; and
an information outputting part for outputting the first predetermined information that has been conditioned to allow the first predetermined information to be stored in the predetermined server so that the first predetermined information can be provided to the first network from the predetermined server.

27. An information management server in accordance with claim 25, wherein
the information acquisition part acquires the second predetermined information at predetermined intervals with the predetermined timing.

28. An information management server in accordance with claim 25, wherein
the information acquisition part deletes the acquired information from the predetermined server when the second predetermined information is acquired from the predetermined server.

29. An information management server in accordance with claim 25, further comprising a firewall that has a security function for the predetermined server.

30. An information management server in accordance with claim 25,
the first network is the Internet; and
the second network is an intranet.

31. An information management server in accordance with claim 25,
the first predetermined information is defect-correcting information concerning a correction of a defect caused on the basis of the use of commodities; and
the second predetermined information is practical-accomplishment information concerning a practical accomplishment of a correction of a defect that has occurred in commodities.

32. A storage medium storing a program that causes a computer to function as a server, the server being an information management server that manages a predetermined server connected to a first network and that gathers the second predetermined information from the first network in accordance with provisions of the first predetermined information, the information management server being connected to a second network different from the first network, the information management server comprising: an information acquisition part for acquiring the second predetermined information that has been gathered by the predetermined server at a predetermined timing; and a database construction part for constructing a predetermined database on the basis of the second predetermined information that has been acquired.

33. A double-server system comprising a first server connected to a first network and a second server connected to a second network,
the first server comprising: a first information storage part for storing first predetermined information; an information providing part for providing the first predetermined information that has been stored therein to the first network; an information inputting part for inputting second predetermined information that has been transmitted from a client computer through the first network; and a second information storage part for storing the second predetermined information that has been input;
the second server comprising: an information acquisition part for acquiring the second predetermined information that has been stored in the second information storage part of the first server at a predetermined timing; and a database construction part for constructing a predetermined database on the basis of the second predetermined information that has been acquired.

34. An double-server system in accordance with claim 33, wherein
the second server further comprises an information conditioning part for conditioning the first predetermined information from the predetermined database that has been constructed, and an information outputting part for outputting the first predetermined information that has been conditioned to the first server so that the first predetermined information is stored in the first information storage part of the first server.

35. An double-server system in accordance with claim 33, wherein
the information acquisition part acquires the second predetermined information at predetermined intervals with the predetermined timing.

36. An double-server system in accordance with claim 33, wherein
the information acquisition part deletes the acquired information from the second information storage part when the second predetermined information is acquired from the second information storage part.

37. An double-server system in accordance with claim 33, wherein
the first server has a firewall for the first network; and
the second server has a firewall for the first server.

38. An double-server system in accordance with claim 33, wherein
the first network is the Internet; and
the second network is an intranet.

39. An double-server system in accordance with claim 33, wherein
the first predetermined information is defect-correcting information concerning a correction of a defect caused on the basis of the use of commodities; and
the second predetermined information is practical-accomplishment information concerning a practical accomplishment of a correction of a defect that has occurred in commodities.

40. A method for gathering and providing information, the method comprising the steps of:
(a) inputting and storing predetermined information that has been transmitted from a client computer through a first network by a first server connected to the first network, and
(b) acquiring the predetermined information stored in the first server at a predetermined timing by a second server connected to a second network, thereafter constructing a database, and providing predetermined information to the second network by using the constructed database.

41. A method in accordance with claim 40, wherein
step (a) is a step of inputting predetermined information from a client connected to the first network through a firewall by the first server; and
step (b) is a step of acquiring predetermined informational from the first server through a firewall by the second server.
